(19) United States
(12) Patent Application Publication
(10) Pub. No.: US 2023/0256539 A1
(43) Pub. Date: Aug. 17, 2023

(54) LASER WELDING METHOD AND LASER WELDING DEVICE

(71) Applicant: FURUKAWA ELECTRIC CO., LTD., Tokyo (JP)

(72) Inventors: Tomomichi YASUOKA, Tokyo (JP); Shinji SATOH, Tokyo (JP); Nobuyasu MATSUMOTO, Tokyo (JP); Sayo SUGA, Tokyo (JP); Fumika NISHINO, Tokyo (JP); Jun TERADA, Tokyo (JP); Kazuyuki UMENO, Tokyo (JP); Masamitsu KANEKO, Tokyo (JP); Takashi SHIGEMATSU, Tokyo (JP)

(73) Assignee: FURUKAWA ELECTRIC CO., LTD., Tokyo (JP)

(21) Appl. No.: 18/301,307

(22) Filed: Apr. 17, 2023

Related U.S. Application Data
(63) Continuation of application No. PCT/JP2021/038559, filed on Oct. 19, 2021.

(30) Foreign Application Priority Data
Oct. 20, 2020 (JP) 2020-176332

(51) Int. Cl. B23K 26/21

(52) U.S. Cl. CPC B23K 26/21

(57) ABSTRACT

A laser welding method includes: preparing a first member and a second member, the first member and the second member having a first end portion and a second end portion in a first direction, respectively; arranging the second member adjacent to the first member in a second direction intersecting with the first direction such that a distance between the first end portion and the second end portion is 0 or more along the first direction; forming a first molten pool protruding from the first end portion toward at least the second end portion, by emitting laser light to the first end portion; forming a bridging molten pool by emitting laser light to at least the first end portion after the forming of the first molten pool, the bridging molten pool bridging over the first end portion and the second portion; and solidifying the bridging molten pool.

### REFERENCE TO RELATED APPLICATION(S)

This application is a continuation of International Application No. PCT/JP2021/038559, filed on Oct. 19, 2021 which claims the benefit of priority of the prior Japanese Patent Application No. 2020-176332, filed on Oct. 20, 2020, the entire contents of which are incorporated herein by reference.

### BACKGROUND OF THE INVENTION

The present disclosure relates to a laser welding method and a laser welding device.

### Description of the Related Art

In a known technique, before plural metallic members, such as rectangular wires, are subjected to laser welding, preprocessing of correcting differences in level and gaps between end portions of the plural metallic members is performed (Patent Literature 1: Japanese Patent No. 6551961).

### SUMMARY OF THE INVENTION

Such preprocessing is one of causes of increase in: manufacturing labor; time required for manufacture; and manufacturing cost.

In that regard, it is desirable to obtain improved and novel laser welding method and laser welding device that enable implementation of laser welding by a more streamlined procedure.

In some embodiments, a laser welding method includes: preparing a first member made of a metallic material and a second member made of a metallic material, the first member and the second member having a first end portion and a second end portion in a first direction, respectively; arranging the second member adjacent to the first member in a second direction intersecting with the first direction such that a distance between the first end portion and the second end portion is 0 or more along the first direction; forming a first molten pool protruding from the first end portion toward at least the second end portion, by emitting laser light to the first end portion; forming a bridging molten pool including a fluid metallic material included in the first molten pool, by emitting laser light to at least the first end portion after the forming of the first molten pool, the bridging molten pool bridging over the first end portion and the second portion; and solidifying the bridging molten pool.

In some embodiments, a laser welding method includes:

preparing a first member made of a metallic material and a second member made of a metallic material, the first member and the second member having a first end portion and a second end portion in a first direction, respectively; arranging the second member adjacent to the first member in a second direction intersecting with the first direction such that a distance between the first end portion and the second end portion is 0 or more along the first direction; forming a first molten pool on at least a portion of the first end portion by emitting laser light to the first end portion, the portion being near the second end portion; forming a bridging molten pool including a fluid metallic material included in the first molten pool, by emitting laser light to at least the first end portion after the forming of the first molten pool, the bridging molten pool bridging over the first end portion and the second portion; and solidifying the bridging molten pool.

In some embodiments, a laser welding method includes: preparing a first member made of a metallic material and a second member made of a metallic material, the first member and the second member having a first end portion and a second end portion in a first direction, respectively; arranging the second member adjacent to the first member in a second direction intersecting with the first direction such that a distance between the first end portion and the second end portion is 0 or more along the first direction; detecting a relative positional relation in the first direction between the first end portion and the second end portion; emitting laser light to another one of the first end portion and second end portion and thereby forming a first molten pool on the other one, a distance between one of the first end portion and second end portion and the other one of the first end portion and second end portion being 0 or more along the first direction; and forming a bridging molten pool including a fluid metallic material included in the first molten pool, by emitting laser light to at least the other one of the first end portion and second end portion after the forming of the first molten pool, the bridging molten pool bridging over the first end portion and the second portion; and solidifying the bridging molten pool.

In some embodiments, provided is a laser welding device that implements laser welding of a first end portion of a first member made of a metallic material and a second end portion of a second member made of a metallic material to each other, the first end portion and the second end portion being in a first direction, the second member being arranged adjacent to the first member in a second direction intersecting the first direction. The laser welding device includes: a light source configured to output laser light;

and an optical head configured to emit the laser light from the light source. The optical head is configured to: emit laser light to an area of another one of the first end portion and second end portion, the area being nearer to one of the first end portion and second end portion than a center of the other one in the second direction, a distance between the one and the other one being 0 or more along the first direction, and thereby form a first molten pool on at least a portion of the other one, the portion being near the one, the first molten pool protruding toward the one; and form a bridging molten pool including a fluid metallic material included in the first molten pool, by emitting laser light to at least the other one after the forming of the first molten pool, the bridging molten pool bridging over the first end portion and the second end portion.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram of an exemplary schematic configuration of a laser welding device according to a first embodiment;

FIG. 2 is an exemplary and schematic side view of a workpiece before welding in a laser welding method according to the first embodiment;

FIG. 3 is an exemplary and schematic side view of the workpiece after the welding in the laser welding method according to the first embodiment;

FIG. 4 is an exemplary and schematic perspective view of a rectangular wire including a member of the workpiece in the laser welding method according to the first embodiment;

FIG. 5 is an exemplary and schematic side view of the workpiece at one stage of temporal change of the workpiece in the laser welding method according to the first embodiment;

FIG. 6 is an exemplary and schematic side view of the workpiece at a stage of the temporal change in the laser welding method according to the first embodiment, the stage being after that in FIG. 5;

FIG. 7 is an exemplary and schematic side view of the workpiece at a stage of the temporal change in the laser welding method according to the first embodiment, the stage being after that in FIG. 6;

FIG. 8 is an exemplary and schematic side view of the workpiece at one stage of the temporal change in the laser welding method according to the first embodiment, in a case where the workpiece changes to a state different from that in FIG. 6 after that in FIG. 5;

FIG. 9 is an exemplary and schematic plan view of an example of sweep routes on end portions in the laser welding method according to the first embodiment;

FIG. 10 is an exemplary and schematic plan view of another example of the sweep routes on the end portions in the laser welding method according to the first embodiment;

FIG. 11 is an exemplary and schematic plan view of yet another example of the sweep routes on the end portions in the laser welding method according to the first embodiment;

FIG. 12 is an exemplary and schematic plan view of still another example of the sweep routes on the end portions in the laser welding method according to the first embodiment;

FIG. 13 is an exemplary and schematic plan view of yet another example of the sweep routes on the end portions in the laser welding method according to the first embodiment;

FIG. 14 is an exemplary and schematic side view of the workpiece at one stage of the temporal change in the laser welding method according to the first embodiment;

FIG. 15 is an exemplary and schematic side view of the workpiece at a stage of the temporal change in the laser welding method according to the first embodiment, the stage being after that in FIG. 14;

FIG. 16 is an exemplary and schematic side view of the workpiece at a stage of the temporal change in the laser welding method according to the first embodiment, the stage being after that in FIG. 15;

FIG. 17 is a perspective view of a modified example of the members serving as the workpiece in the laser welding method according to the first embodiment;

FIG. 18 is a perspective view of another modified example of the members serving as the workpiece in the laser welding method according to the first embodiment;

FIG. 19 is a perspective view of yet another modified example of the members serving as the workpiece in the laser welding method according to the first embodiment;

FIG. 20 is a side view of a modified example of a laser light emission direction and a position irradiated with laser light, for the members serving as the workpiece in the laser welding method according to the first embodiment;

FIG. 21 is a side view of another modified example of the laser light emission direction and the position irradiated with laser light, for the members serving as the workpiece in the laser welding method according to the first embodiment;

FIG. 22 is an exemplary block diagram of the laser welding device according to the first embodiment;

FIG. 23 is an exemplary flowchart illustrating a procedure by the laser welding device according to the first embodiment; and

FIG. 24 is a diagram of an exemplary schematic configuration of a laser welding device according to a second embodiment.

### DETAILED DESCRIPTION

Exemplary embodiments of the disclosure and modified examples thereof will be disclosed hereinafter. Configurations of the embodiments and modified examples described hereinafter and functions and results (effects) brought about by these configurations are just examples. The disclosure may be implemented by configurations other than those disclosed hereinafter with respect to the embodiments and modified examples. Furthermore, the disclosure achieves at least one of various effects (including derivative effects) achieved by these configurations.

The following embodiments and modified examples have similar components. The same reference sign will be assigned to any components that are the same and redundant explanation thereof may be omitted, hereinafter.

Furthermore, in each drawing, a direction X is indicated by an arrow X, a direction Y by an arrow Y, and a direction Z by an arrow Z. The direction X, the direction Y, and the direction Z intersect one another and are orthogonal to one another. The Z direction is a direction in which plural members extend, the plural members serving as a workpiece W. The Z direction is approximately vertically upward but may be inclined with respect to a vertically upward direction.

Ordinals are assigned for convenience to distinguish between parts, portions, and directions, for example, in this specification, but do not indicate any priority or order.

### First Embodiment

### Outline of Laser Welding Device and Laser Welding

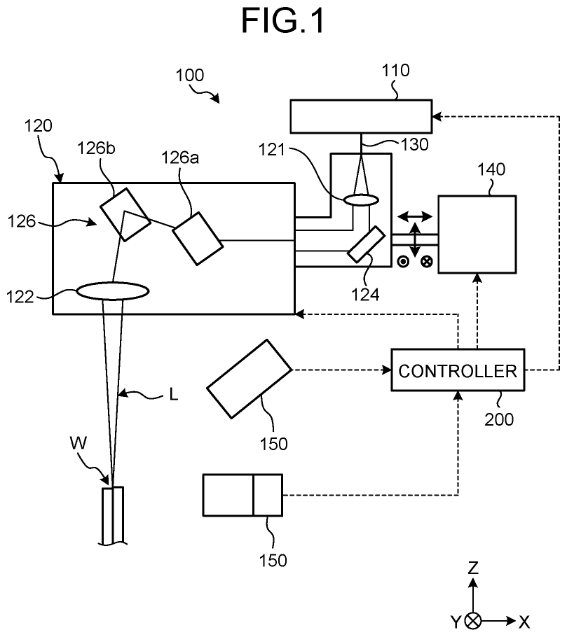

FIG. 1 is a diagram illustrating a schematic configuration of a laser welding device 100 according to a first embodiment. As illustrated in FIG. 1, the laser welding device 100 includes a laser device 110, an optical head 120, an optical fiber 130, a drive mechanism 140, a sensor 150, and a controller 200.

The laser welding device 100 emits laser light L to a surface of a workpiece W subjected to laser welding. Energy of the laser light L melts part of the workpiece W, the molten part of the workpiece W is cooled and solidifies, and welding of the workpiece W is thereby done. The workpiece W has plural members and the plural members are joined to each other by laser welding.

The plural members serving as the workpiece W may each be made of, for example, a copper-based metallic material, such as copper or a copper alloy, or an aluminum-based metallic material, such as aluminum or an aluminum alloy. The plural members may be made of the same metallic material or may be made of metallic materials that are different from each other. The plural members serving as the workpiece W may each be a conductor or not a conductor.

The laser device 110 includes a laser oscillator and is, for example, configured to be capable of outputting single-mode laser light having power of a few kilowatts (kW). The laser device 110 may include, for example, plural semiconductor laser elements inside the laser device 110, and may be configured to be capable of outputting multi-mode laser light having power of a few kW as total output of the plural semiconductor laser elements. The laser device 110 may include any of various laser light sources, such as fiber lasers, YAG lasers, and disk lasers. The laser device 110 may output continuous waves of laser light or output pulses of laser light. Furthermore, in this first embodiment, the laser device 110 outputs laser light having a wavelength of, for example, 400 nm or longer and 1200 nm or shorter. The laser oscillator included in the laser device 110 is an example of a light source.

The optical fiber 130 connects the laser device 110 and the optical head 120 optically to each other. In other words, the optical fiber 130 guides laser light output from the laser device 110, to the optical head 120. In a case where the laser device 110 is to output single-mode laser light, the optical fiber 130 is configured to propagate the single-mode laser light therethrough. In this case, the M² beam quality of the single-mode laser light is set to 1.3 or less. The M² beam quality may also be called the M² factor.

The optical head 120 is an optical device for emitting laser light input from the laser device 110, to the workpiece W. The optical head 120 has a collimator lens 121, a condenser lens 122, a mirror 124, and a galvano scanner 126. The collimator lens 121, the condenser lens 122, the mirror 124, and the galvano scanner 126 may also be called optical components.

The collimator lens 121 collimates laser light input via the optical fiber 130. The laser light that is collimated becomes collimated light.

The mirror 124 reflects laser light that has become collimated light at the collimator lens 121, to cause the reflected laser light to head to the galvano scanner 126. The mirror 124 may be unnecessary depending on the direction in which the laser light is input from the optical fiber 130 and the arrangement of the collimator lens 121.

The galvano scanner 126 has plural mirrors 126a and 126b, controls angles of the plural mirrors 126a and 126b to thereby change the direction in which laser light L from the optical head 120 is output, and thereby enables change in the position irradiated with the laser light L, the position being on the surface of the workpiece W. The angles of the mirrors 126a and 126b are respectively changed by, for example, motors controlled by the controller 200, the motors not being illustrated in the drawings. Changing the direction in which the laser light L is output while the laser light L is being emitted enables the laser light L to sweep across the surface of the workpiece W.

The condenser lens 122 condenses laser light that is collimated light coming from the galvano scanner 126 and outputs the laser light as laser light L (output light) to the workpiece W.

The optical components that the optical head 120 has are not limited to those described above, and the optical head 120 may have another optical component. For example, the optical head 120 may have a diffractive optical element (DOE) as a beam shaper that shapes a beam of laser light.

The drive mechanism 140 changes position of the optical head 120, the position being relative to the workpiece W. The drive mechanism 140 has, for example: a rotation mechanism, such as a motor; a deceleration mechanism that decelerates rotation output from the rotation mechanism; and a motion conversion mechanism that converts the rotation decelerated by the deceleration mechanism to linear motion. The controller 200 is capable of controlling the drive mechanism 140 so that the position of the optical head 120 in the X direction, Y direction, and Z direction is changed, the position being relative to the workpiece W. The drive mechanism 140 is capable of changing (switching) the workpiece W to be subjected to laser welding to another one of plural workpieces W that are being supported by a support mechanism (not illustrated in the drawings). The drive mechanism 140 is also capable of changing the position irradiated with laser light L, the position being on the workpiece W. In addition, the drive mechanism 140 may be used in change of the irradiation point, the change being associated with the change in the direction in which laser light is emitted to the workpiece W. The drive mechanism 140 is also capable of changing the irradiation position in a state where the laser light L is being emitted onto the surface of the workpiece W. That is, the drive mechanism 140 is able to cause the laser light L to sweep across the surface of the workpiece W.

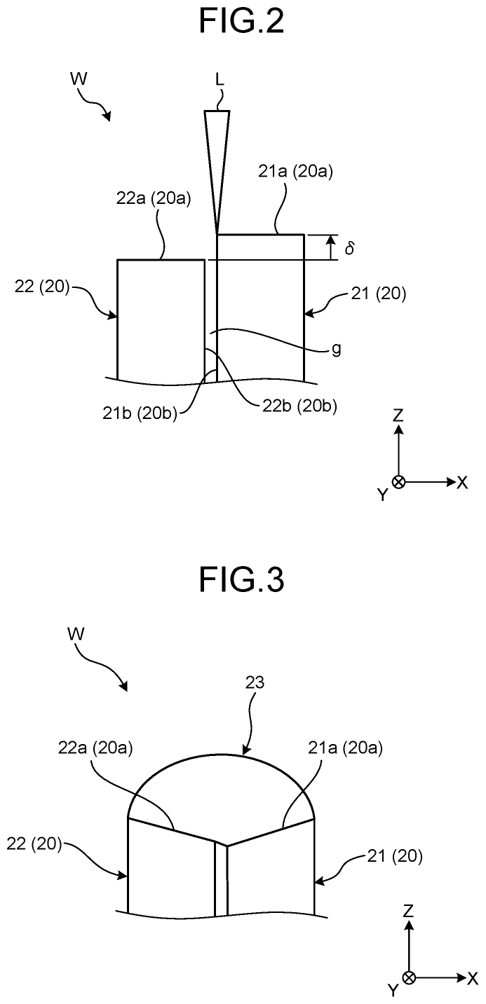

FIG. 2 is a side view illustrating a state of the workpiece W before welding. As illustrated in FIG. 2, the workpiece W has two members 20 (21 and 22). The two members 20 are each made of a metallic material.

The two members 20 each extend in the Z direction and each have an end portion 20a (21a or 22a) in the Z direction. The end portions 20a extend to intersect the Z direction. That is, the end portions 20a extend both in the X direction and the Y direction. The Z direction is an example of a first direction.

The two members 20 are adjacent to each other in the X direction intersecting the Z direction and are lined up in the X-direction. A gap g is formed between side surfaces 21b and 22b (20b) facing each other in the X direction. The gap g has a size of 0 or larger. That is, the two members 20 may be in contact with each other at least partly. The X direction is an example of a second direction.

In this first embodiment, the Z direction displacement of the end portion 21a of the member 21 from the end portion 22a of the member 22 is assumed to be 0 or more. That is, of the two members 20 that are in such a relative positional relation, the end portion 21a that is at the same position as the end portion 22a in the Z direction or is displaced in the Z direction from the end portion 22a is an example of a first end portion and the end portion 22a displaced in an opposite direction from the end portion 21a is an example of a second end portion, the opposite direction being opposite to the Z direction. The member 21 having the end portion 21a is an example of a first member and the member 22 having the end portion 22a is an example of a second member. The member 21 (first member) may also be called a member that is relatively protruded in the Z direction and the member (second member) may also be called a member that is relatively recessed in the Z direction.

The sensor 150 (see FIG. 1) obtains detected values and data for detection of a relative positional relation between the two end portions 20a in the Z direction. The sensor 150 is, for example, a 2D camera, a 3D camera, such as an RGB-D camera, or a non-contact displacement sensor.

The controller 200 is capable of detecting, on the basis of detected values or data obtained from at least one sensor 150, displacement δ (≥0) of the end portion 21a from the end portion 22a in the Z direction. That is, the controller 200 is capable of determining the end portion 21a having the displacement δ of 0 or more relative to the other end portion 22a in the Z direction.

The optical head 120 emits laser light L to the end portion 20a when the workpiece W, that is, the two members 20 are welded to each other. The direction in which the laser light L is emitted is a direction opposite to the Z direction or a direction inclined with respect to the direction opposite to the Z direction.

FIG. 3 is a side view illustrating a state of the workpiece W after welding. As illustrated in FIG. 3, emission of laser light L to the end portions 20a melts the two members 20 at the end portions 20a and a welded portion 23 bridging over the two end portions 20a is formed. The welded portion 23 is a molten pool that has been formed in a state of bridging over the two end portions 20a, has then been cooled, and has solidified. The molten pool that is a metallic material having fluidity bulges in the Z direction due to surface tension. As a result, the welded portion 23, which is the molten pool that has solidified, also bulges in the Z direction. The welded portion 23 mechanically connects the two members 21 and 22 to each other. Furthermore, in a case where the two members 21 and 22 are metal having electric conductivity, the welded portion 23 electrically connects the two members 21 and 22 to each other.

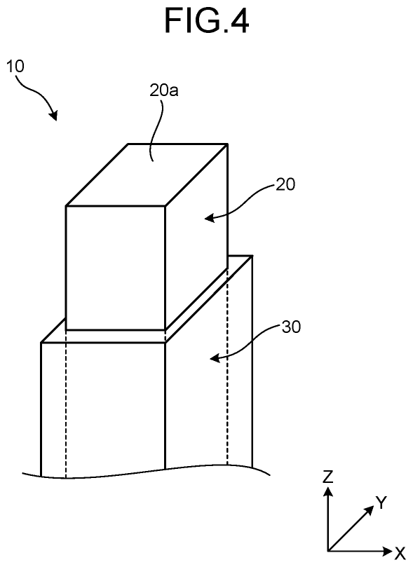

FIG. 4 is a perspective view of a rectangular wire 10 including one of the members 20. The member 20 is, for example, a core (inner conductor) of the rectangular wire 10 illustrated in FIG. 4. The rectangular wire 10 has the member 20 and covering 30 for the member 20. The member 20 is made of a metallic material having electric conductivity. The shape of a cross section of the member 20 is approximately rectangular, the cross section being orthogonal to the direction in which the member 20 extends. The covering 30 is insulating and is made of, for example, enamel or a synthetic resin material. The covering 30 may have an enamel layer and an extrusion resin layer surrounding the enamel layer. The laser welding device 100 is applied to welding of the end portions 20a of the members 20 to each other, the members 20 serving as cores of such rectangular wires 10. In this case, part of their covering 30 is removed, the part being near end portions of the covering 30, the end portions being in the direction in which the two rectangular wires 10 extend. As illustrated in FIG. 2, the end portions 20a of the two members 20 that have been arranged to be directed in the same direction (the extending direction) and adjacent to each other are welded to each other by the laser welding device 100.

The rectangular wires 10 may be included in coils provided in a rotary electric machine. A laser welding method by the laser welding device 100 according to the first embodiment is applicable to welding of end portions of coils to each other, the coils having been set in a stator core and being adjacent to each other.

However, the members 20 serving as the workpiece W are not necessarily the cores of the rectangular wires 10, and as illustrated in FIG. 2, may be any members extending in the Z direction, adjacent to each other in the X direction, having end portions 20a near each other, and having side surfaces 20b facing each other in the X direction. The members 20 may be plate-like members or wires. Laser Welding Method

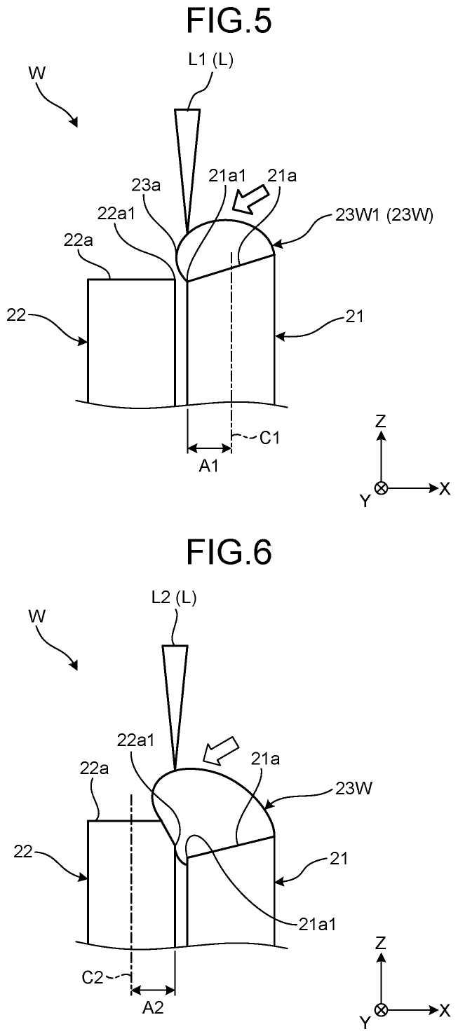

FIG. 5 to FIG. 7 are diagrams illustrating temporal change in laser welding of the two members 21 and 22 that are in an initial state illustrated in FIG. 2. For convenience of explanation, hereinafter, laser light L emitted to the end portion 21a will be referred to as laser light L1 and laser light L emitted to the end portion 22a will be referred to as laser light L2, but the laser light L1 and the laser light L2 are both output from the same optical head 120.

Firstly, as illustrated in FIG. 5, laser light L1 (L) is emitted to the end portion 21a of the member 21. In this emission, the laser light L1 is emitted, for example, to or near an edge 21a1 of the end portion 21a, the edge 21a1 being near the end portion 22a. The emission of the laser light L1 to the end portion 21a forms a molten pool 23W1 on the end portion 21a. The molten pool 23W1 is formed by melting of the metallic material of the member 21. That is, the molten pool 23W1 includes the metallic material of the member 21 having fluidity.

At a stage where a time period of about, for example, 0.2 seconds has elapsed from start of emission of laser light L1, the molten pool 23W1 bulges in the Z direction on the end portion 21a and protrudes toward the end portion 22a from the edge 21a1, that is, toward the member 22, due to surface tension. In other words, the molten pool 23W1 has a protruding portion 23a that protrudes toward the end portion 22a. This is considered to be because of formation of the molten pool 23W1 around an area A1 by the emission of the laser light L1 to the area A1, the area A1 being nearer to the end portion 22a than the center C1 of the end portion 21a in the X direction. It may also be because: the nearer a portion of the end portion 21a is to the end portion 22a, the more melted the portion is, and the end portion 21a is thereby sloped such that a near end of the end portion 21a is lower, the near end being near the end portion 22a, and a far end of the end portion 21a is higher, the far end being far from the end portion 22a; and force thus acts, due to gravity, on the molten pool 23W1 having fluidity, the force being in a downward direction along the slope. In a case where the member 21 is wider in the X direction, the molten pool 23W1 is formed on a portion of the end portion 21a, the portion being near the end portion 22a. That is, the molten pool 23W1 is formed on at least a portion of the end portion 21a, the portion being near the end portion 22a. The molten pool 23W1 may be said to be formed on the edge 21a1. The molten pool 23W1 is an example of a first molten pool.

FIG. 6 illustrates a stage after FIG. 5, the stage being after elapse of a time period of, for example, about 0.3 seconds from the start of the emission of the laser light L1. At this stage, a molten pool 23W is larger in volume and in size than the one at the stage in FIG. 5, is deformed so as to fall over toward the end portion 22a due to gravity, and comes into contact with the end portion 22a. That is, the molten pool 23W bridges over the end portion 21a and the end portion 22a. Because the molten pool 23W corresponds to the molten pool 23W1 in FIG. 5 that has increased in volume, the molten pool 23W includes components of the metallic material included in the molten pool 23W1, that is, components of the metallic material of the member 21. Furthermore, as illustrated in FIG. 6, due to emission of laser light L2 (L) to or near an edge 22a1 of the end portion 22a, the edge 22a1 being near the end portion 21a, and melting of the end portion 22a due to heat from the molten pool 23W, the molten pool 23W also includes components of the metallic material of the member 22. At this stage, the laser light L2 is preferably emitted to an area A2 of the end portion 22a, the area A2 being nearer to the end portion 21a than the center C2 of the end portion 22a in the X direction. The molten pool 23W bridging over the end portions 21a and 22a is an example of a bridging molten pool.

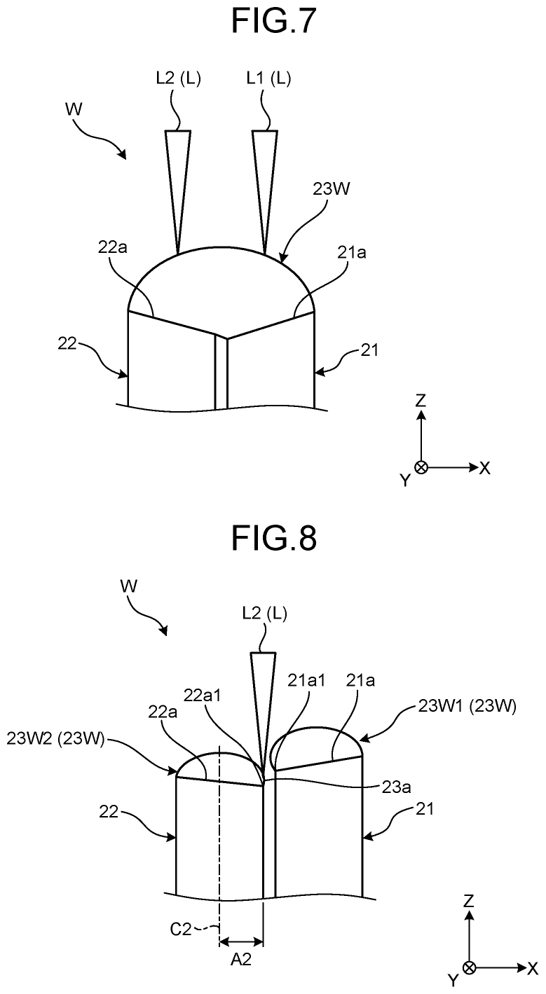

FIG. 7 illustrates a stage after FIG. 6, the stage being after elapse of a time period of, for example, about 0.4 seconds from the start of the emission of the laser light L1. At this stage, the molten pool 23W is larger in volume and size than that at the stage in FIG. 6. Furthermore, melting of the end portion 22a has progressed from the stage in FIG. 6, the end portion 22a has moved downward, and positions of the end portions 21a and 22a in the Z direction have become closer to each other than those at the stage in FIG. 6. After the stage in FIG. 6, until the molten pool 23W has a certain volume or a predetermined shape, the laser light L1 and L2 (L) may be emitted to the molten pool 23W to maintain its molten state or to be shaped into the predetermined shape.

After the stage in FIG. 7, in response to stop of the emission of the laser light L, the molten pool 23W is cooled and becomes the welded portion 23 illustrated in FIG. 3.

The molten pool 23W that becomes the welded portion 23 is not necessarily formed by the method in FIG. 5 to FIG. 7, and laser light L may be emitted after the stage in FIG. 5 so that a state in FIG. 8 is reached. FIG. 8 is a side view that is at a stage after that in FIG. 5 and before that in FIG. 7 but different from that in FIG. 6. In this case, as illustrated in FIG. 8, similarly to FIG. 5, after the molten pool 23W1 is formed on the end portion 21a, laser light L2 (L) is emitted to the end portion 22a of the member 22. In this emission, the laser light L2 is emitted, for example, to or near the edge 22a1 of the end portion 22a, the edge 22a1 being near the end portion 21a. The emission of the laser light L2 to the end portion 22a forms a molten pool 23W2 on the end portion 22a. The molten pool 23W2 is formed by melting of the metallic material of the member 22. That is, the molten pool 23W2 includes the metallic material of the member 22 having fluidity.

The molten pool 23W2 bulges in the Z direction on the end portion 22a and protrudes from the edge 22a1 toward the end portion 21a, that is, toward the member 21, due to surface tension. In other words, the molten pool 23W2 has a protruding portion 23a that protrudes toward the end portion 21a. This is considered to be because of formation of the molten pool 23W2 around the area A2 by emission of the laser light L2 to the area A2, the area A2 being nearer to the end portion 21a than the center C2 of the end portion 22a in the X direction. It may also be because the nearer a portion of the end portion 22a is to the end portion 21a, the more melted the portion is, and the end portion 22a is thereby sloped such that a near end of the end portion 22a is lower, the near end being near the end portion 21a, an a far end of the end portion 22a is higher, the far end being far from the end portion 21a; and force acts, due to gravity, on the molten pool 23W2 having fluidity, the force being in a downward direction along the slope. In a case where the member 22 is wider in the X direction, the molten pool 23W2 is formed on a portion of the end portion 22a, the portion being near the end portion 21a. That is, the molten pool 23W2 is formed on at least a portion of the end portion 22a, the portion being near the end portion 21a. The molten pool 23W2 may be said to be formed on the edge 22a1. In this case, the molten pool 23W2 does not necessarily protrude toward the end portion 21a. The molten pool 23W2 is an example of a second molten pool.

After the stage in FIG. 8, the molten pool 23W1 formed on the end portion 21a and the molten pool 23W2 formed on the end portion 22a are united with each other to form a molten pool 23W illustrated in FIG. 7. Thereafter, the molten pool 23W is cooled and solidifies, and the welded portion 23 illustrated in FIG. 3 is thereby formed.

FIG. 5 to FIG. 8 exemplify the case where there is the gap g larger than 0 between the members 21 and 22, but temporal change similar to that illustrated in FIG. 5 to FIG. 8 may occur in a case where the gap g is 0, that is, in a case where the members 21 and 22 are in contact with each other in the X direction. Furthermore, in a case where the members 21 and 22 are in contact with each other and the end portions 21a and 22a are near each other, the molten pool 23W1 may have become the molten pool 23W bridging over the end portions 21a and 22a by the time the molten pool 23W1 is formed.

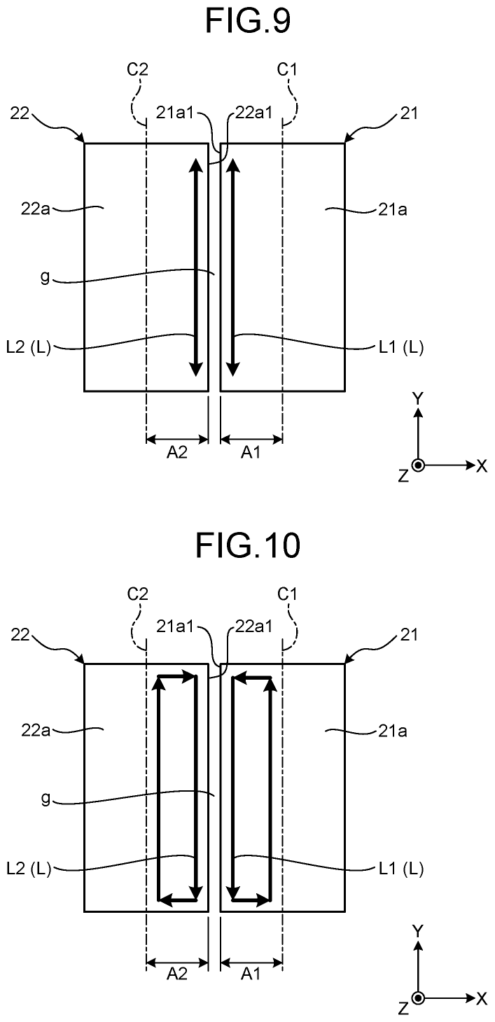

FIG. 9 is an explanatory diagram illustrating an example of sweep routes of the laser light L1 and laser light L2 on the end portions 21a and 22a. At the stages where the laser light L1 and laser light L2 are emitted as illustrated in FIG. 5 to FIG. 8, for example, the laser light L1 linearly sweeps the area A1 in the Y direction intersecting the X direction, the area A1 being nearer to the end portion 22a than the center C1 of the end portion 21a in the X direction, as illustrated in FIG. 9. The laser light L2 linearly sweeps the area A2 in the Y direction intersecting the X direction, the area A2 being nearer to the end portion 21a than the center C2 of the end portion 22a in the X direction, for example. The sweeping by the laser light L1 and laser light L2 in the areas A1 and A2 may each: be performed a plural number of times; or reciprocate between the Y direction end portions. The Y direction is an example of a third direction.

As described above, causing the laser light L1 and laser light L2 to linearly sweep the areas A1 and A2 along the Y direction enables formation of the molten pools 23W1 and 23W2 extending in the Y direction respectively along the edges 21a1 and 22a1. It has also been found that voids in the welded portion 23 are reduced in a case where sweeping is performed linearly. This is considered to be because of minimization of disorder in flows of the metallic materials having fluidity in the molten pools 23W1, 23WW2, and 23W having fluidity. Furthermore, performing linear and reciprocating sweeping enables: thermal energy to be imparted as needed to wider ranges of the molten pools 23W1, 23W2, and 23W; and thus local cooling and solidification of the molten pools 23W1, 23W2, and 23W to be minimized.

FIG. 10 is an explanatory diagram illustrating an example of the sweep routes of the laser light L1 and laser light L2 on the end portions 21a and 22a, the example being different from that in FIG. 9. In the example of FIG. 10, the laser light L1 and laser light L2 linearly sweep the areas A1 and A2 respectively along the Y direction at both a position near the end portion 22a or 21a and a position far from the end portion 22a or 21a. Because the emission of the laser light L1 and laser light L2 is continuously performed, sweeps in the X direction are also included near the Y direction end portions of the areas A1 and A2. The sweep directions are not limited to the ones illustrated in FIG. 10.

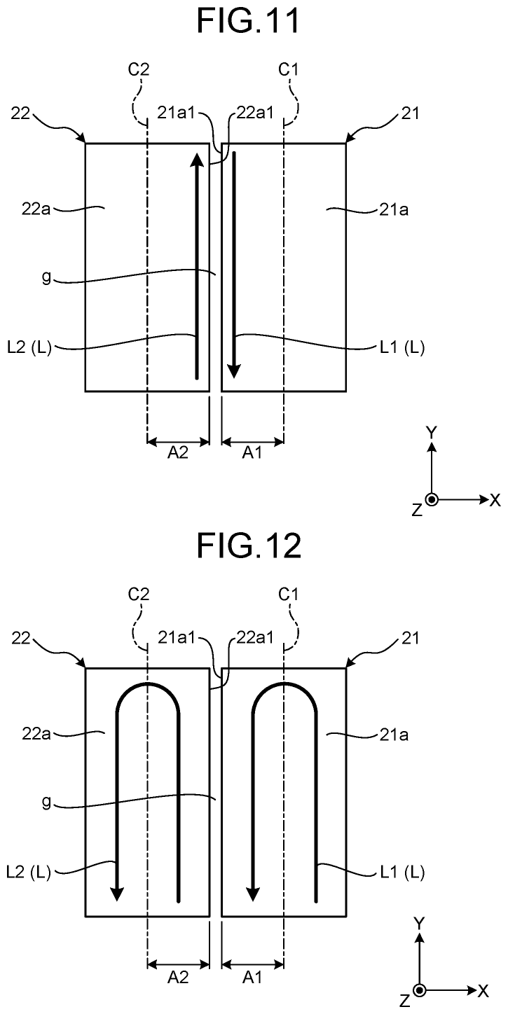

FIG. 11 is an explanatory diagram illustrating an example of the sweep routes of the laser light L1 and laser light L2 on the end portions 21a and 22a, the example being different from those in FIG. 9 and FIG. 10. In the example of FIG. 11, the laser light L1 sweeps the area A1 in a direction opposite to the Y direction and the laser light L2 sweeps the area A2 in the Y direction. The sweep in the direction opposite to the Y direction in the area A1 and the sweep in the Y direction in the area A2 may be repeatedly performed a plural number of times. The sweep directions in the areas A1 and A2 may be opposite to those in FIG. 11, may both be the Y direction, or may both be the direction opposite to the Y direction.

At least one fixed point may be irradiated with the laser light L1 in the area A1, although this is not illustrated in the drawings. For example, a central portion between the Y direction end portions of the area A1 may be irradiated with the laser light L1 once or a plural number of times. Furthermore, plural points positioned in the area A1 at intervals in the Y direction may be irradiated with the laser light L1 and each of these plural points may be irradiated with the laser light L1 a plural number of times. At least one fixed point may be irradiated with the laser light L2 in the area A2. For example, a central portion between the Y direction end portions of the area A2 may be irradiated with the laser light L2 once or a plural number of times. Furthermore, plural points positioned in the area A2 at intervals in the Y direction may be irradiated with the laser light L2 and each of these plural points may be irradiated with the laser light L2 a plural number of times.

FIG. 12 is an explanatory diagram illustrating an example of the sweep routes of the laser light L1 and laser light L2 on the end portions 21a and 22a, the example being different from those in FIG. 9 to FIG. 11. In the example of FIG. 12, the sweep routes go through areas other than the areas A1 and A2 on the end portions 21a and 22a, the areas each being farther from the other end portion 22a or 21a than the center C1 or C2 of the end portion 21a or 22a in the X direction. Such sweep routes also enable formation of the molten pools 23W1 and 23W2 and thus the molten pool 23W as described above. In addition, as illustrated in FIG. 12, the sweep routes may include curved sections. In this case, the change in sweep velocity is able to be reduced as compared to a case where a sweep route includes a turning back section or a bending section.

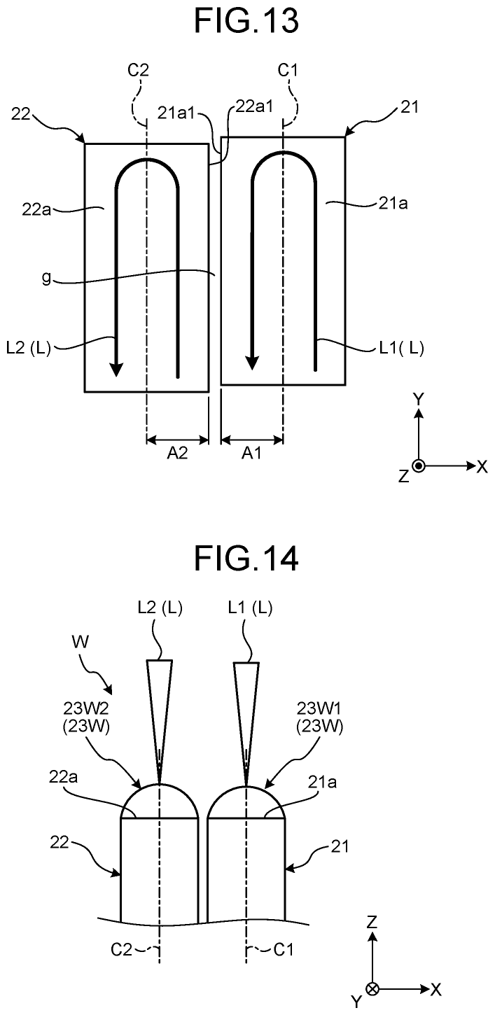

Furthermore, as illustrated in FIG. 13, the end portions 21a and 22a may be displaced from each other in the Y direction. In such a case also, formation of the molten pools 23W1 and 23W2, and thus the molten pool 23W as described above is enabled.

The sweep by the laser light L illustrated in FIG. 9 to FIG. 13 is comparatively fast and is thus implemented mainly by operation of the galvano scanner 126. However, without being limited to this example, the sweep may be implemented by operation of the drive mechanism 140, or a combination of operation of the galvano scanner 126 and operation of the drive mechanism 140.

Furthermore, FIG. 14 to FIG. 16 are diagrams illustrating temporal change in a case where the molten pools 23W1, 23W2, and 23W are formed via states different from those in FIGS. 5 to 8.

Firstly, as illustrated in FIG. 14, emission of laser light L1 and laser light L2 forms the molten pools 23W1 and 23W2 respectively on the end portions 21a and 22a.

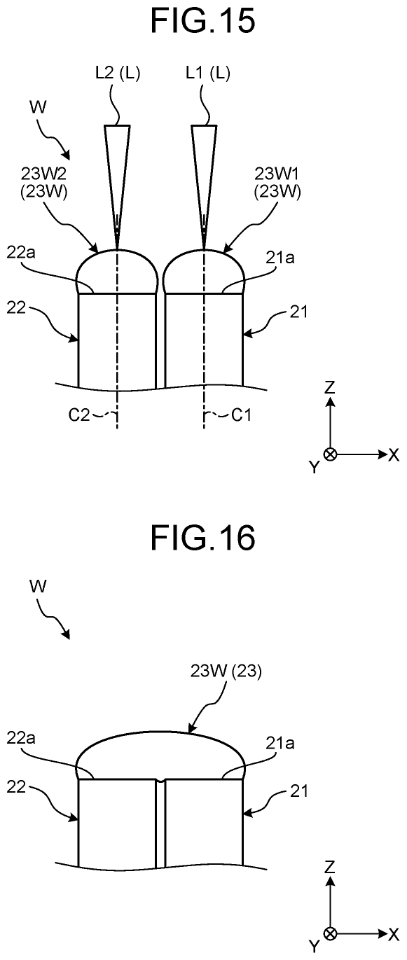

Subsequently, as illustrated in FIG. 15, the molten pools 23W1 and 23W2 grow respectively on the end portions 21a and 22a, and protrude in directions intersecting the Z direction, the directions including directions in which the molten pools 23W1 and 22W2 respectively approach the other end portions 22a and 21a.

As illustrated in FIG. 16, the molten pools 23W1 and 23W2 that have come close to each other by protruding to each other are united with each other and the molten pool 23W bridging over the end portions 21a and 22a, that is, a bridging molten pool is formed.

As described above, the molten pools 23W1 and 23W2 may be united with each other by at least one of the molten pools 23W1 and 23W2 protruding to the other to approach the other, instead of one of the molten pools 23W1 and 23W2 falling over toward the other to be united with the other. In FIG. 14 and FIG. 15, the laser light L1 and laser light L2 are emitted to the approximate centers C1 and C2 (centers in the X direction or on the center lines) of the end portions 21a and 22a for sweeping, but without being limited to this example, the laser light L1 and laser light L2 may be emitted to areas of the end portions 21a and 22a, the areas each being closer to the other end portions 22a or 21a than the center C1 or C2, or may be emitted to areas of the end portions 21a and 22a, the areas each being farther from the other end portion 22a or 21a than the center C1 or C2.

### Modified Examples of Members

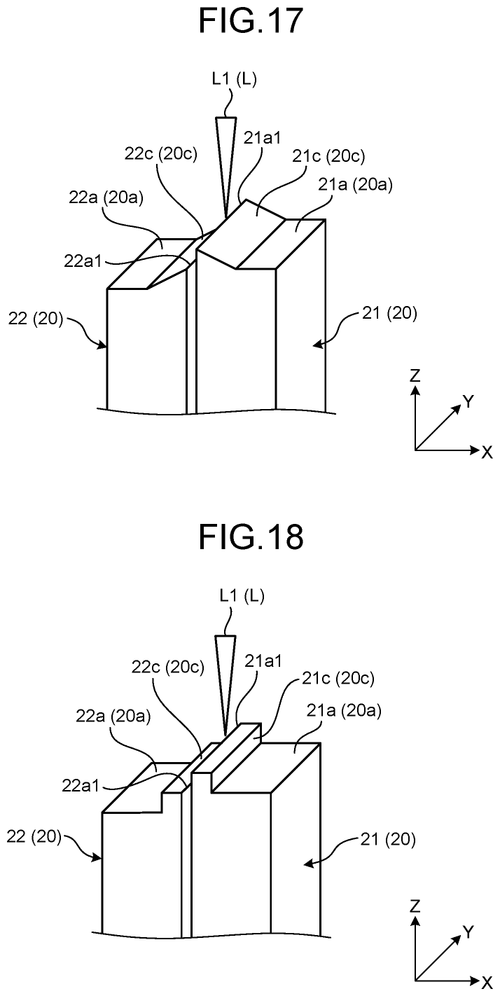

FIG. 17 is a perspective view illustrating a modified example of the two members 20. As illustrated in FIG. 17, the members 20 may each have a projecting portion 20c that projects in the Z direction from the end portion 20a, that is, in the direction in which the member 20 extends. A projecting portion 21c (20c) of the member 21 is provided nearer to the end portion 22a than the center of the end portion 21a in the X direction and along the edge 21a1, and projects to be higher in the Z direction toward the edge 21a1. By contrast, a projecting portion 22c (20c) of the member 22 is provided nearer to the end portion 21a than the center of the end portion 22a in the X direction and along the edge 22a1, and projects to be higher in the Z direction toward the edge 22a1.

FIG. 18 is a perspective view illustrating another modified example of the two members 20. As illustrated in FIG. 18, the members 20 each have a projecting portion 20c in the example of FIG. 18 also. A projecting portion 21c (20c) of the member 21 is provided nearer to the end portion 22a than the center of the end portion 21a in the X direction and a projecting portion 22c (20c) of the member 22 is provided nearer to the end portion 21a than the center of the end portion 22a in the X direction. However, in this modified example, the projecting portion 21c has a wall-like shape having thickness that is approximately constant in the X direction and extending in the Y direction.

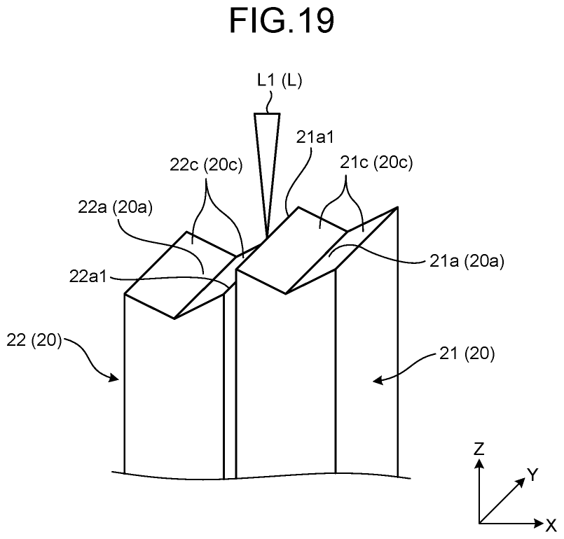

FIG. 19 is a perspective view illustrating another modified example of the two members 20. As illustrated in FIG. 19, the members 20 each have a projecting portion 20c in the example of FIG. 19 also. However, in this modified example, the projecting portion 20c has a plane symmetry shape with the symmetry center on a symmetry plane passing the center of the end portion 20a in the X direction. That is, the end portion 21a has two projecting portions 21c (20c), the projecting portion 21c near the edge 21a1 protrudes to be higher in the Z direction toward the edge 21a1, and the projecting portion 21c far from the edge 21a1 projects to be higher in the Z direction with distance from the edge 21a1. Furthermore, the end portion 22a has two projecting portions 22c (20c), the projecting portion 22c near the edge 22a2 protrudes to be higher in the Z direction toward the edge 22a1, and the projecting portion 22c far from the edge 22a2 projects to be higher in the Z direction with distance from the edge 22a1. This plane symmetry shape enables obtainment of a structure in which mutually adjacent portions in an area where the two end portions 20a are adjacent to each other project more than the centers, regardless of the direction in which the rectangular wire 10 is bent, the mutually adjacent portions being near the edges 21a1 and 22a1. The projecting portions 21c in FIG. 19 have the plane symmetry shapes based on the projecting portions 21c similar to those in FIG. 17, but may instead have plane symmetry shapes based on the projecting portions 21c similar to those in FIG. 18.

In a case where the projecting portion 21c like the one illustrated in any one of FIG. 17 to FIG. 19 is provided, as compared to a case where no projecting portion 21c is provided, portions of the end portions 20a are able to be efficiently molten by emission of the laser light L to the projecting portion 21c in a shorter period of time and the time required for welding is thus able to be shortened even more, the portions being around the edges 21a1 and 22a1 of the end portions 21a and 22a, the edges 21a1 and 22a1 each being near the other end portion 22a or 21a. As to the projecting portion 21c, the end portion 21a may just have a portion (a high portion) displaced in the Z direction from the center of the end portion 21a in the X direction, the portion being nearer to the end portion 22a than the center of the end portion 21a in the X direction, and the end portion 22a may just have a portion (a high portion) displaced in the Z direction from the center of the end portion 22a in the X direction, the portion being nearer to the end portion 21a than the center of the end portion 22a in the X direction. The end portions 20a may have, instead of the projecting portions 20c in FIG. 19, projecting portions 20c having shapes different from those in FIG. 19 by each having portions (high portions) displaced in the Z direction from the center of the end portion 20a in the X direction, the high portions being on both sides of the center of the end portion 20a in the X direction. The end portions 20a may each have a shape with a portion (a high portion) displaced in the Z direction from the center of the end portion 20a, the portion being around the center of the end portion 20a. In other words, a recessed portion that is recessed at the center of the recessed portion may be provided in the end portion 20a.

### Modified Examples of Emission Direction and Irradiation Position

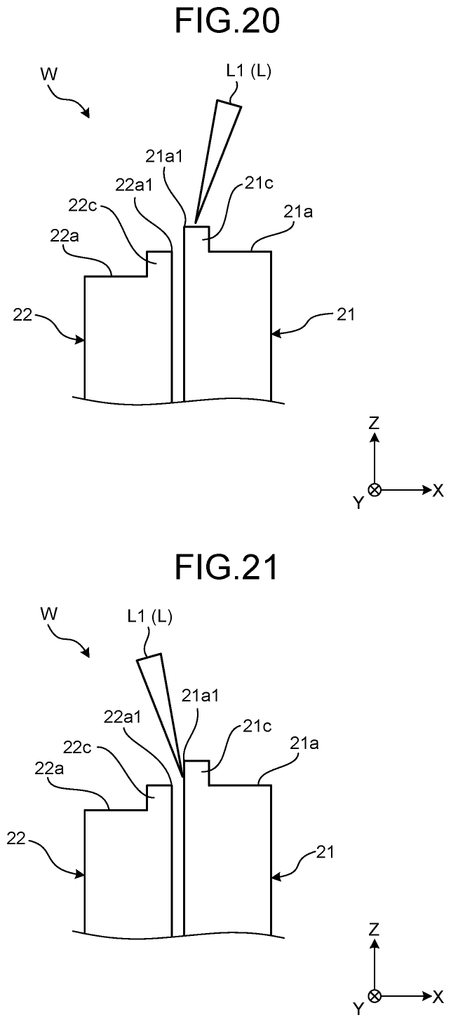

FIG. 20 is a side view illustrating a modified example of the direction in which laser light L1 (L) is emitted and the position irradiated with the laser light L1 (L). As illustrated in FIG. 20, the direction in which laser light L1 is emitted to the end portion 21a may be a direction in which the laser light L1 approaches the end portion 22a as the laser light L1 heads in the direction opposite to the Z direction. In this case, power of the laser light L1 facilitates faster movement of the molten pool 23W1 toward the end portion 22a.

FIG. 21 is a side view illustrating a modified example of the direction in which the laser light L1 (L) is emitted and the position irradiated with the laser light L1 (L), the modified example being different from that in FIG. 20. As illustrated in FIG. 21, the direction in which the laser light L1 is emitted to the end portion 21a may be a direction in which the laser light L1 is away from the end portion 22a as the laser light L1 heads in the direction opposite to the Z direction (that is, in a state before melting of the end portions 21a and 22a, the laser light L1 is emitted to an area of the side surface 21b, the area protruding from the end portion 22a). In this case, energy of the laser light L1 is able to be imparted to a portion nearer to the edge 21a1 (end portion 22a), the molten pool 23W1 is able to be formed to be positioned nearer to the end portion 22a, and the molten pool 23W (bridging molten pool) is thus able to be formed even faster. Furthermore, in this case, emitting the laser light L1 to the side surface of the projecting portion 21c, the side surface being near the end portion 22a, that is, irradiating a position displaced in the direction opposite to the Z direction from a distal end of the end portion 21a and projecting portion 21c, the distal end being in the Z direction, enables formation of the molten pool 23W1 in a shorter time period, and together with the above described effect of emitting the laser light L1 in the direction in which the laser light L1 is away from the end portion 22a as the laser light L1 heads in the direction opposite to the Z direction, enables the time required for welding to be shortened even more.

### Block Diagram of and Procedure by Laser Welding Device

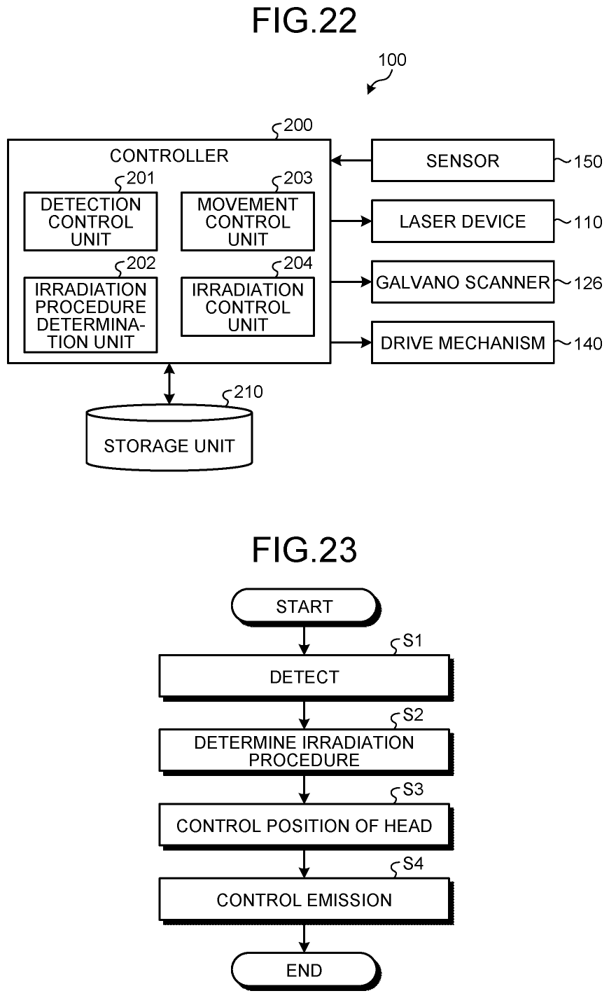

FIG. 22 is a block diagram of the laser welding device 100. The laser welding device 100 includes, for example, the controller 200, a storage unit 210, the sensor 150, the laser device 110, the galvano scanner 126, and the drive mechanism 140.

The controller 200 is a computer and has a processor (circuitry), such as a central processing unit (CPU), and a main storage unit, such as a random access memory (RAM) and a read only memory (ROM). The controller 200 is, for example, a micro controller unit (MCU). The storage unit 210 has, for example, a non-volatile storage device, such as a solid state drive (SSD) or a hard disk drive (HDD). The storage unit 210 may also be called an auxiliary storage device.

By executing processes by reading programs stored in the ROM or the storage unit 210, the processor operates as a detection control unit 201, an irradiation procedure determination unit 202, a movement control unit 203, and an irradiation control unit 204. By being recorded in a computer-readable recording medium, the programs may each be provided as a file having an installable format or an executable format. The recording medium may also be called a program product. The programs, and information, such as values used in arithmetic processing by the processor, tables, and maps, may be stored in the ROM or the storage unit 210 beforehand, or may be stored in a storage unit of a computer connected to a communication network to be stored in the storage unit 210 by being downloaded via the communication network. The storage unit 210 stores data written by the processor. Furthermore, at least part of arithmetic processing executed by the controller 200 may be executed by hardware. In this case, the controller 200 may include, for example, a field programmable gate array (FPGA) or an application specific integrated circuit (ASIC).

FIG. 23 is a flowchart of a procedure for the workpiece W at one place by the laser welding device 100. As illustrated in FIG. 23, firstly, the controller 200 operates as the detection control unit 201 and obtains detected values and data from the sensor 150 (S1). Furthermore, at this S1, the detection control unit 201 detects, on the basis of the detected values and data from the sensor 150, a relative positional relation between the end portions 21a and 22a. The sensor 150 and the detection control unit 201 are an example of a detection unit.

Subsequently, the controller 200 operates as the irradiation procedure determination unit 202 and determines an irradiation procedure for the laser light L (S2). At this S2, the irradiation procedure determination unit 202 firstly determines, on the basis of the relative positional relation between the two end portions 20a in the Z direction, the end portion 21a (first end portion) and end portion 22a (second end portion). That is, the irradiation procedure determination unit 202 determines one end portion 20a of the two end portions 20a as the end portion 22a, that is, the second end portion, and the other one end portion 20a of the two end portions 20a as the end portion 21a, that is, the first end portion, the other one end portion 20a being at the same position as the one end portion 20a in the Z direction or being displaced in the Z direction from the one end portion 20a.

Subsequently, at S2, the irradiation procedure determination unit 202 generates, for example, a sequence of control commands for targets to be controlled, such as the laser device 110, the galvano scanner 126, and the drive mechanism 140, for executing the above described irradiation procedure for the laser light L, that is, a welding method. The irradiation procedure for the laser light L is, for example, a procedure in which laser light L is emitted to the end portion 21a first, the laser light L2 is emitted to the end portion 22a next, and the laser light L is thereafter emitted to the molten pool 23W. The irradiation procedure determination unit 202 stores the generated sequence of control commands into the storage unit 210. The irradiation procedure may be set so that parameters related to emission of the laser light L in the laser welding method are changed as appropriate according to, for example, the relative positional relation between the end portions 21a and 22a, the parameters being, for example, output of the laser light L, the irradiation position, the emission direction, the sweep velocity, and the emission timing. The targets to be controlled are a mechanism capable of changing the state of emission of laser light and may also be called a variable mechanism.

Subsequently, the controller 200 operates as the movement control unit 203, reads the sequence stored in the storage unit 210, and controls the drive mechanism 140 to move, according to the sequence, the optical head 120 to a position defined by the irradiation procedure (S3). Furthermore, the controller 200 operates as the irradiation control unit 204, reads the sequence stored in the storage unit 210, and controls the laser device 110 and galvano scanner 126 to execute emission of the laser light L according to the irradiation procedure, in accordance with the sequence (S4). S3 and S4 may be repeatedly executed as appropriate. The procedure according to the flow in FIG. 23 by the laser welding device 100 is executed one by one for workpieces W at plural places. The irradiation procedure determination unit 202, the movement control unit 203, and the irradiation control unit 204 are an example of a control unit.

As described above, in the laser welding method according to the first embodiment, for example, laser light L is emitted to the area A1 nearer to the end portion 22a (second end portion) than the center of the end portion 21a (first end portion), and the molten pool 23W1 (first molten pool) protruding toward the end portion 22a is thereby formed on at least the portion of the end portion 21a, the portion being near the end portion 22a. Subsequently, laser light L is emitted to at least the end portion 21a, and the molten pool 23W (bridging molten pool) including the fluid metallic material included in the molten pool 23W1 and bridging over the end portion 21a and end portion 22a is thereby formed. Subsequently, cooling and solidifying the molten pool 23W form the welded portion 23.

The laser welding method and the laser welding device that executes the laser welding method enable: elimination of preprocessing, such as making heights of the end portions 21a and 22a the same; and faster or more efficient welding of the end portions 21a and 22a to each other. Therefore, for example, the labor, time required, and cost for welding are able to be reduced, and the labor, time required, and cost for manufacture of a device including the welded portion 23 are thus able to be reduced. Furthermore, forming the molten pool 23W by emission of laser light L to the end portion 21a has the advantage of making it easier to reduce the displacement between the end portions 21a and 22a in the Z direction, the end portion 21a having the displacement of 0 or more in the Z direction from the end portion 22a.

Furthermore, the molten pool 23W may be formed by the movement of the molten pool 23W1 to fall over toward the end portion 22a due to gravity like in the first embodiment.

The end portions 21a and 22a are thereby able to be molten and the welded portion 23 is able to be formed, faster or more efficiently, for example.

Furthermore, like in this first embodiment, before the forming of the molten pool 23W, emission of laser light L2 to the area A2 nearer to the end portion 21a than the center of the end portion 22a may be performed.

Advantages are thereby obtained, the advantages being, for example, that the molten pool 23W2 is able to be formed on the area A2 of the end portion 22a and the molten pool 23W is able to be formed faster, and that the end portion 22a is able to be molten faster upon preheating of the area A2 and contact between the molten pool 23W and the end portion 22a and the intended molten pool 23W is able to be formed faster.

Furthermore, like in this first embodiment, the molten pool 23W2 (second molten pool) may be formed on at least the portion of the end portion 22a, the portion being near the end portion 21a, the molten pool 23W1 and the molten pool 23W2 may be united with each other, and the molten pool 23W may thereby be formed.

The end portions 21a and 22a are thereby able to be molten and the welded portion 23 is able to be formed, faster or more efficiently, for example.

In a case where the positions of the end portion 21a and end portion 22a are displaced from each other in the Z direction, the amount of displacement is preferably equal to or less than the amount of protrusion of the molten pool 23W in the Z direction from the edge 21a1 or 22a1 (for example, equal to or less than 1.5 mm), the amount of protrusion being the larger one of the amounts of protrusion of the molten pool 23W from the edges 21a1 and 22a1 in the Z direction in a state where the molten pool 23W (bridging molten pool) has solidified in this first embodiment, for faster welding of the members 21 and 22 to each other.

### Second Embodiment

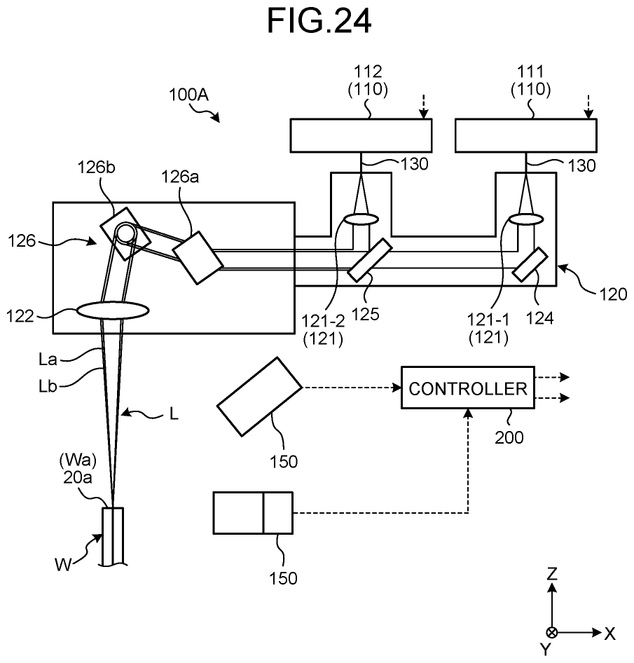

FIG. 24 is a diagram illustrating a schematic configuration of a laser welding device 100A according to a second embodiment. As illustrated in FIG. 24, the laser welding device 100A includes two laser devices 111 and 112, as the laser device 110.

The laser device 111 outputs, for example, laser light having a wavelength of 800 nm or longer and 1200 nm or shorter, and the laser device 112 outputs, for example, laser light having a wavelength of 550 nm or shorter. More preferably, the laser device 112 outputs, for example, laser light having a wavelength of 400 nm or longer and 500 nm or shorter. Laser oscillators included in the laser devices 111 and 112 are an example of light sources. Furthermore, the laser light output by the laser device 111 is an example of first laser light and the laser light output by the laser device 112 is an example of second laser light. The laser devices 111 and 112 may output continuous waves of laser light or output pulses of laser light.

The controller 200 is capable of controlling operation of each of the laser devices 111 and 112. For example, the controller 200 is capable of controlling the laser devices 111 and 112 to output laser light, stop output of laser light, and change output intensity.

Laser light output from the laser devices 111 and 112 is input to the optical head via the optical fiber 130.

The mirror 124 reflects first laser light that has become collimated light at a collimator lens 121-1. The first laser light reflected by the mirror 124 heads to a wavelength filter 125 serving as an optical component.

The wavelength filter 125 is a high-pass filter that transmits the first laser light from the laser device 111 therethrough and reflects the second laser light from the laser device 112 without transmitting the second laser light therethrough. The first laser light is transmitted through the wavelength filter 125 and heads to the galvano scanner 126. The wavelength filter 125 reflects the second laser light that has become collimated light at a collimator lens 121-2. The second laser light reflected by the wavelength filter 125 heads to the galvano scanner 126. The galvano scanner 126 operates similarly to the one according to the first embodiment.

The condenser lens 122 condenses laser light that is collimated light coming from the galvano scanner 126 and outputs the condensed laser light as laser light L (output light or emitted light) to the workpiece W. The laser light L includes first laser light La and second laser light Lb.

The second laser light Lb is absorbed at a higher rate by a metallic material, such as a copper based material or an aluminum based material, because the second laser light Lb is shorter in wavelength than the first laser light La. The first laser light La is higher in convergence and is more easily increased in power density because the first laser light La is longer in wavelength than the second laser light Lb. Therefore, as compared to laser light L including only the first laser light La or second laser light Lb, the laser light L including the first laser light La and second laser light Lb enables greater stabilization of the molten pools 23W1 and 23W2 (23W) as an effect of the second laser light Lb and more efficient melting of the metallic material as an effect of the first laser light La. Therefore, the second embodiment enables more efficient execution of higher quality laser welding with less voids and spattering.

Examples of embodiments and modified examples of the disclosure have been described above, but these embodiments and modified examples are just examples and are not intended to limit the scope of the invention. The above described embodiments and modified examples can be implemented in various other modes, and without departing from the gist of the invention, various omissions, substitutions, combinations, and modifications can be made. Furthermore, they may be implemented by modifying, as appropriate, the specifications of the components and shapes, for example (such as, the structures, types, directions, models, sizes, lengths, widths, thicknesses, heights, numbers, arrangements, positions, and materials).

For example, in emission of laser light, for example, publicly known wobbling, weaving, or output modulation may be performed and the surface area of the molten pool may thereby be adjusted.

Furthermore, laser light may be concurrently emitted to both the first end portion and second end portion.

The disclosure enables, for example, obtainment of improved and novel laser welding method and laser welding device that enable implementation of laser welding by a more streamlined procedure.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser welding method comprising:
preparing a first member made of a metallic material and a second member made of a metallic material, the first member and the second member having a first end portion and a second end portion in a first direction, respectively;
arranging the second member adjacent to the first member in a second direction intersecting with the first direction such that a distance between the first end portion and the second end portion is 0 or more along the first direction;
forming a first molten pool protruding from the first end portion toward at least the second end portion, by emitting laser light to the first end portion;
forming a bridging molten pool including a fluid metallic material included in the first molten pool, by emitting laser light to at least the first end portion after the forming of the first molten pool, the bridging molten pool bridging over the first end portion and the second portion; and
solidifying the bridging molten pool.

2. The laser welding method according to claim 1, wherein the forming of the first molten pool includes emitting laser light to an area nearer to the second end portion than a center of the first end portion in the second direction.

3. The laser welding method according to claim 1, wherein the forming of the bridging molten pool includes forming the bridging molten pool by the first molten pool moving to fall over toward the second end portion.

4. The laser welding method according to claim 1, further comprising, after the forming of the first molten pool and before the forming of the bridging molten pool, emitting laser light to the second end portion.

5. The laser welding method according to claim 4, wherein the emitting of the laser light to the second end portion includes emitting the laser light to an area nearer to the first end portion than a center of the second end portion in the second direction.

6. The laser welding method according to claim 4, wherein
the emitting of the laser light to the second end portion includes forming a second molten pool on at least a portion of the second end portion, the portion being near the first end portion, and
the forming of the bridging molten pool includes forming the bridging molten pool by the first molten pool and the second molten pool uniting with each other.

7. The laser welding method according to claim 1, wherein the forming of the bridging molten pool includes irradiating plural points in the bridging molten pool with the laser light.

8. The laser welding method according to claim 1, wherein the forming of the first molten pool includes performing sweeping with the laser light in a third direction intersecting both of the first direction and second direction.

9. The laser welding method according to claim 8, wherein the forming of the first molten pool includes performing the sweeping with the laser light in the third direction a plural number of times.

10. The laser welding method according to claim 1, wherein the forming of the first molten pool includes performing irradiation of at least one fixed point with the laser light.

11. The laser welding method according to claim 1, further comprising, after the forming of the first molten pool and before the forming of the bridging molten pool, emitting laser light to the second end portion, the emitting including performing sweeping with the laser light in a third direction intersecting both of the first direction and second direction.

12. The laser welding method according to claim 11, wherein the performing of the sweeping with the laser light in the third direction intersecting both of the first direction and second direction includes performing the sweeping with the laser light in the third direction a plural number of times.

13. The laser welding method according to claim 1, further comprising, after the forming of the first molten pool and before the forming of the bridging molten pool, emitting laser light to the second end portion, the emitting including irradiating at least one fixed point with the laser light.

14. The laser welding method according to claim 1, wherein
the first end portion has a projecting portion that projects in the first direction, and
the forming of the first molten pool includes emitting the laser light to the projecting portion.

15. The laser welding method according to claim 14, wherein the projecting portion projects from a portion of the first end portion, the portion being nearer to the second end portion than a center of the first end portion in the second direction.

16. The laser welding method according to claim 1, wherein the forming of the first molten pool includes emitting the laser light in a direction in which the laser light approaches the second end portion toward a direction opposite to the first direction.

17. The laser welding method according to claim 1, wherein the forming of the first molten pool includes emitting the laser light in a direction in which the laser light is away from the second end portion toward a direction opposite to the first direction.

18. The laser welding method according to claim 17, wherein the forming of the first molten pool includes emitting the laser light to a position displaced in a direction opposite to the first direction from a distal end of the first end portion, the distal end being in the first direction.

19. The laser welding method according to claim 1, wherein
the first member has a first side surface that extends in both: a third direction intersecting both of the first direction and second direction; and the first direction, and
the second member has a second side surface that extends in the third direction and the first direction and that faces the first side surface.

20. The laser welding method according to claim 19, wherein the first member and the second member are conductors of rectangular wires.

21. The laser welding method according to claim 1, wherein the second end portion is arranged at a position different from the first end portion in the first direction.

22. A laser welding method comprising:
preparing a first member made of a metallic material and a second member made of a metallic material, the first member and the second member having a first end portion and a second end portion in a first direction, respectively;
arranging the second member adjacent to the first member in a second direction intersecting with the first direction such that a distance between the first end portion and the second end portion is 0 or more along the first direction;
forming a first molten pool on at least a portion of the first end portion by emitting laser light to the first end portion, the portion being near the second end portion;
forming a bridging molten pool including a fluid metallic material included in the first molten pool, by emitting laser light to at least the first end portion after the forming of the first molten pool, the bridging molten pool bridging over the first end portion and the second portion; and
solidifying the bridging molten pool.

23. A laser welding method comprising:
preparing a first member made of a metallic material and a second member made of a metallic material, the first member and the second member having a first end portion and a second end portion in a first direction, respectively;
arranging the second member adjacent to the first member in a second direction intersecting with the first direction such that a distance between the first end portion and the second end portion is 0 or more along the first direction;
detecting a relative positional relation in the first direction between the first end portion and the second end portion;
emitting laser light to another one of the first end portion and second end portion and thereby forming a first molten pool on the other one, a distance between one of the first end portion and second end portion and the other one of the first end portion and second end portion being 0 or more along the first direction; and
forming a bridging molten pool including a fluid metallic material included in the first molten pool, by emitting laser light to at least the other one of the first end portion and second end portion after the forming of the first molten pool, the bridging molten pool bridging over the first end portion and the second portion; and
solidifying the bridging molten pool.

24. A laser welding device that implements laser welding of a first end portion of a first member made of a metallic material and a second end portion of a second member made of a metallic material to each other, the first end portion and the second end portion being in a first direction, the second member being arranged adjacent to the first member in a second direction intersecting the first direction, the laser welding device comprising:
a light source configured to output laser light; and
an optical head configured to emit the laser light from the light source, wherein
the optical head is configured to:
emit laser light to an area of another one of the first end portion and second end portion, the area being nearer to one of the first end portion and second end portion than a center of the other one in the second direction, a distance between the one and the other one being 0 or more along the first direction, and thereby form a first molten pool on at least a portion of the other one, the portion being near the one, the first molten pool protruding toward the one; and
form a bridging molten pool including a fluid metallic material included in the first molten pool, by emitting laser light to at least the other one after the forming of the first molten pool, the bridging molten pool bridging over the first end portion and the second end portion.

25. The laser welding device according to claim 24, further comprising:
a detector configured to perform detection of a relative positional relation in the first direction between the first end portion and the second end portion; and
a controller configured to determine, based on a result of the detection by the detector, the one and the other one of the first end portion and second end portion, and control a target to be controlled such that the first molten pool and the bridging molten pool are formed.
